(19) United States
(12) Patent Application Publication
(10) Pub. No.: US 2019/0054676 A1
(43) Pub. Date: Feb. 21, 2019

(54) Method for the manufacture of a tube

(71) Applicant: Promix Solutions AG, Winterthur (CH)

(72) Inventor: Rolf Heusser, Winterthur (CH)

(73) Assignee: Promix Solutions AG, Winterthur (CH)

(21) Appl. No.: 16/056,771

(22) Filed: Aug. 7, 2018

(30) Foreign Application Priority Data
Aug. 16, 2017 (EP) EP 17186501.7

(51) Int. Cl. B29C 47/88; B29C 47/06; B29C 47/00

(52) U.S. Cl. CPC B29C 47/882; B29C 47/065; B29K 2023/12; B29K 2023/06; B29C 47/0023

(57) ABSTRACT

A method for the manufacture of a tube (10) containing a plastic material is proposed. The plastic material is melted in an extruder (3) so that a plastic melt is obtained, wherein the extruder (3) includes a passage (5). A conveyor (4) is arranged in the passage (5). The passage (5) has a first end (6), wherein the plastic material is introduced downstream of the first end (6) into the passage (5). The plastic material is conveyed through the passage (5, 35) and is converted into a plastic melt. The passage (5) has a second end (7), wherein the plastic melt is directed through the passage (5) into a forming tool (8). The tube (10) is produced by means of the forming tool (8), wherein the tube (10) leaves the passage (5) at the second end (7), wherein the tube (10) leaves the passage (5) on the second end (7). The plastic melt is guided through a cooling device (9), wherein the cooling device (9) comprises a cooling element (19) and a mixing element (40, 41), which is arranged in the interior of the passage (5, 35), wherein the plastic melt flows around the cooling element (19, 49) and the mixing element (40, 41), so that the plastic melt is cooled through the cooling element (19, 49) and the plastic melt is mixed by the mixing element (40, 41).

### TECHNICAL FIELD

The invention relates to a method for the manufacture of a tube. In particular, the invention relates to a method for producing a thick-walled tube containing a plastic material. Under a thick-walled tube it is to be understood in the following a tube whose wall thickness is at least 3 mm. In particular, the invention relates to a method for producing a tube with a small thickness tolerance.

A challenge in the manufacture of thick walled tubes is to manufacture the tubes with a tight thickness tolerance. Since the cooling time is very long for thick-walled tubes, a flow of the plastic material, usually a polymer, occurs during the cooling process due to the gravitational force acting on the thick-walled tube. If the longitudinal axis of the tube is horizontal, the still fluid plastic material flows from the top of the tube to the bottom. Since the flow of the plastic material comprises a mass transport, such a flow leads to a different circumferential thickness of the tube. For example, the tube may have a greater thickness on its underside than on the upper side. This effect is referred to in the following as sagging effect. This sagging effect increases with the thickness of the tube wall, with an increasing tube diameter and the decrease of the viscosity of the melt.

### DESCRIPTION OF RELATED ART

The document CH 399729 A describes a method and a device for producing tubes made of thermoplastic material. A forming tool for making such a tube, which is defined as a self-supporting, elongated, hollow structure, includes a nozzle head and a heated die attached to this nozzle head. The heated die has an outlet that essentially defines the outer surface of the tube. A mandrel disposed axially within the die head of the die substantially defines the inner surface of the tube. The polymer melt flows around the mandrel. The mandrel comprises a heated part and a cooled part. A thin elastic skin of solid polymer is formed around the cooled part of the mandrel within the die, which makes it easier to peel off the tube, especially when the polymer mass outside the skin is still liquid and, in that state, could still adhere to the surface of the mandrel. As a result, the surface quality of the inner wall of the tube is impaired, which can be avoided by the cooled mandrel. To produce a tube of uniform thickness, the tube is passed over a rolling mill after leaving the die. The rolling mill comprises a plurality of rollers, by means of which the tube wall is pressed against an inner body, for example a cone. The rollers have a defined distance from the inner body, so that the thickness of the tube can be specified exactly.

CH 399729 A thus shows a heatable and coolable mandrel as an example of a heating and cooling device in the forming tool for the production of tubes with the aim of improving the surface quality on the inside of the tube. As the annular channel contains no mixing elements, the polymer melt can't be homogenized, so that in this example, a device according to EP3100843 A1 can be used for this purpose. In addition, the tactile surface of the mandrel or the jacket, which surrounds the mandrel to form the annular channel is very small compared to the flow channel. Therefore, this device is not suitable for preventing the sagging effect. Due to the limited coolable surface, it can be cooled only to a limited extent. In addition, the heat transfer in the plastic melt is low and the device also is subject to a non-uniform flow, freezing or to a decomposition of the plastic melt due to the lack of mixing effect at high cooling capacity.

Today, special, very high-viscosity polymers are used for the production of thick-walled tubes, which naturally show a low tendency of any sagging effect. Even by making use of these highly viscous polymers, the sagging effect can't be completely avoided. Attempts are also made to counteract the sagging effect by means of a non-centric tool outlet gap, thus compensating for it. However, such a correction is optimally possible only for a single process point. This means that if the temperature, the throughput or tube diameter are changed, or another polymer is used, a sagging effect is still to be expected or the tool has to be readjusted when changing only one of these parameters, resulting in downtime, which leads to increased costs.

It is also currently sought to keep the melt in the coldest state possible by appropriate extruder settings in the extruder outlet to achieve the fastest possible solidification, such that any sagging effect can be avoided due to the rapid cooling. This method also has its process engineering limits, since the polymers with the highest viscosities build up a high pressure in the extruder. Thereby, frictional heat is created in the extruder, consequently, the melt can't be cooled to any possible extent.

Also, an attempt has already been made to install a static mixer between the extruder and the forming tool. In the literature, a perforated plate, as shown in CH 399729 A, was considered to perform the function of a static mixer. However, this perforated plate for the plastic melt does not perform the function of a static mixer, especially when dealing with a viscous plastic melt. Although the plastic melt flows through the perforations, it is recombined immediately downstream of the perforations, without any rearrangement or deflection of the strands of the plastic melt leaving the perforations of the perforated plate. Therefore, the perforated plate is not suitable to function as a static mixer for the present application. Another disadvantage of a perforated plate is that the perforated plate causes an additional heating of the plastic melt due to the additional pressure loss, which in turn favors the sagging effect, An external oil cooling of the mixer in a double jacket mounted on the mixer housing does not provide sufficient cooling of the plastic melt, since the cooling surface is very small in relation to the throughput.

Attempts have also been made to incorporate static coolers between the extruder and the forming tool to further cool the plastic melt downstream of the extruder, such as plate heat exchangers or shell and tube heat exchangers. However, the use of static coolers is problematic for these very viscous polymers, since deposits are easily formed and there are large residence time differences, which lead to the degradation of the polymers and thus no uniform temperature distribution can be generated in the plastic melt. Accordingly, these previously mentioned measures have not led to a satisfactory solution yet.

The object of the invention is to provide a method for producing a thick-walled tube, by means of which the tube is obtained in the desired thickness with low thickness tolerance already at the nozzle exit.

### SUMMARY OF THE INVENTION

The object of the invention is achieved by a method according to claim 1. Advantageous variants of the method are the subject matter of claims 2 to 15.

A method for the manufacture of a tube containing a plastic material comprises the following method steps. The plastic material is melted in an extruder, so that a plastic melt is obtained. The extruder includes a passage in which a conveyor, for example an extruder screw, is arranged, wherein the passage has a first end. The plastic material is introduced into the passage downstream of the first end. The plastic material is conveyed through the passage and converted into a plastic melt. The passage has a second end. The plastic melt is directed through the passage into a forming tool, wherein by means of the forming tool, the tube is made. The tube leaves the passage at the second end. The passage in the forming tool includes a mandrel, so that the plastic melt flows from the passage into an annular passage arranged in the forming tool, wherein the annular passage is arranged around the mandrel. The plastic melt is guided through a cooling device. The cooling device includes a cooling element and a mixing element, which is arranged in the interior of the passage, wherein the plastic melt flows around the cooling element and the mixing element, so that the plastic melt is cooled by the cooling element and the plastic melt is mixed by the mixing element. The cooling element is arranged at least partially within the mixing element.

The cooling can be performed in particular by a cooling element, which is mounted at an angle not equal to 90 degrees or not parallel to the direction of flow. If a plurality of cooling elements is provided, at least a part of the cooling elements can be arranged not parallel to one another. The plastic melt can be deflected in the tube by the one or more cooling elements, or it can be deflected in the annular space and relocated by the cooling element. At least part of the cooling elements may be configured as mixing elements.

According to an embodiment, the cooling device includes a static mixer or is designed as a static mixer, wherein the static mixer includes the cooling element or the cooling elements and the mixing element or the mixing elements. The plastic melt is homogenized by the cooling element. A homogenized plastic melt is understood to be a plastic melt whose temperature is essentially constant with respect to a cross-sectional area arranged normal to the direction of flow. By a substantially constant temperature, it is meant that the maximum temperature of the plastic melt differs from the minimum temperature of the plastic melt downstream of the cooling device by no more than 10 degrees, preferably by not more than 5 degrees.

In particular, the maximum temperature of the plastic melt differs from the minimum temperature of the plastic melt at the second end of the passage by not more than 10 degrees Celsius, preferably not more than 5 degrees Celsius. Due to this narrow range of temperatures, the flow properties of the plastic melt in the core region of the flow and in the wall region thereof are substantially the same. The plastic melt is thus homogenized downstream of the cooling device over the flow cross section.

The cooling element is thus arranged in the plastic melt flow. The plastic melt is thus cooled not only on the inner wall of the outer tube or on the outer wall of the inner tube, but also in the flow core.

The mixing element or the cooling element may comprise a plurality of web elements, which may be arranged crosswise to each other. At least part of the web elements may include a cooling passage. The cooling passage is to be understood as a preferred embodiment of a cooling element. A cooling fluid passes through the cooling passage, such that the heat is transferred from the plastic melt to the cooling fluid. The flow velocity and/or the inlet temperature of the cooling fluid in the cooling passage can be variable, such that the cooling capacity of the cooling element can be adapted by adjusting the flow velocity and/or the inlet temperature of the cooling fluid.

The tube is cooled downstream of the second end, that is, after leaving the forming tool. Since the plastic melt has already cooled sufficiently by the use of the cooling device, any flow processes resulting from the action of gravity forces are no longer possible or at least greatly reduced in the tube cross section. The tube can thus be cooled in any orientation, that means, the orientation of the tube has no significant effects on the cross-section of the tube. That means, that the tube central axis may extend in any spatial direction, it may be arranged for example horizontally, as shown in CH399729 A, or at an inclination angle with respect to the horizontal plane, which is shown for example in DE 2650911 A1.

According to an embodiment, the tube has a wall thickness of at least 3 mm. The tube may in particular have an outer diameter of at least 100 mm. According to an embodiment, the tube has a wall thickness of at least 20 mm. The tube may in particular have an outer diameter of at least 200 mm. A cooling element for cooling of the plastic melt which is suitable to cool the flow core and to mix the flow of the flow core with the flow of the boundary layers is a particular advantageous configuration for a thick-walled tube having a wall thickness of at least 20 mm and an outer diameter of at least 200 mm. Due to the simultaneous cooling and mixing, the temperature of the flow core substantially corresponds to the temperature of the boundary layer of the flow. The heat transfer between the cooling element and the plastic melt is surprisingly at least 50% higher compared to a cooler which allows only a cooling of the plastic melt via jacket of the passage. This surprising increase in the heat transfer compared to the devices of the prior art is due to the efficient renewal of the boundary layers by the cooling elements according to one of the preceding embodiments.

According to an embodiment, the tube has a wall thickness of at least 40 mm. The tube may in particular have an outer diameter of at least 400 mm.

According to an embodiment, the tube contains at least two layers. A tube containing a plurality of layers can be used if special requirements are placed on the tube, The physical, thermal or chemical properties of each of the layers may differ from the properties of the other layers.

According to an embodiment, each of the layers comprising at least 10% by weight of the polymer melt can be cooled by means of a cooling device. The cooling devices of each of the layers may be independent of each other.

In particular, each of the layers can be produced by a respective extruder, each of the layers being guided through its own passage. The two passages can be combined in the forming tool to form a single passage. In particular, each of the passages may be configured as an annular passage in the forming tool. The annular passages can be arranged concentrically with respect to each other.

According to one embodiment, the conveyor may for example contain a piston or an extruder screw. The extruder can be designed in particular as a single-screw extruder. Each of the components, in particular the conveyor, cooling device and the forming tool, can be arranged in a line. All components or at least two of the components may have a common longitudinal axis, which is formed as a straight line. It is also possible to arrange each of the components at an angle with respect to each other, that is, at an angle to one of the adjacent components, which is in particular not equal to 180 degrees. In particular, each of the components can be connected by an arc element to the adjacent component. A cooling section can extend from the second end. The cooling section can have a length of up to 100 m, for particularly thick-walled tubes a length of up to 200 m. The cooling section may be in particular configured as a channel. According to one embodiment, the channel may have a straight course, so that a straight thick-walled tube of any length is obtainable.

The passage can include a first passage portion containing the conveyor. The passage may include a second passage portion that connects to the first passage portion. The passage can include a third passage portion that connects to the second passage portion. In particular, the third passage portion can include the forming tool.

According to an embodiment, the plastic melt passes the cooling device in the second passage portion, the cooling device is arranged according to this embodiment in the second passage portion. A cooling device may also be provided in each of the other passage portions,

The plastic melt may contain at least one element from the group consisting of polyethylene or polypropylene. In particular, the percentage of polyethylene or polypropylene may be at least 50% by weight.

According to an embodiment, the cooling device is arranged upstream of the forming tool. According to an embodiment, the cooling device is located downstream of the extruder. According to an embodiment, the cooling device is arranged between the extruder and the forming tool.

The invention relates to a device for the manufacture of a tube containing a plastic material, an extruder, wherein the extruder comprises a conveyor, for example an extruder screw or a piston, which is arranged in a passage. The passage has a first end, the passage containing the plastic material downstream of the first end. The passage is connected via a supply line with a plastic material reservoir. The plastic material can be stored in the storage container in solid form, for example as a powder or in the form of pellets. The plastic material is fed into the passage via the supply line. The passage contains a heat supply device or is connected to a heat supply device, so that the plastic material in the passage is convertible to a plastic melt. The passage has a second end so that the passage forms a connection for the plastic melt from the extruder to a forming tool. The forming tool includes an annular passage for producing the tube from the plastic melt, wherein the annular passage extends to the second end.

The second end includes an opening for the discharge of the plastic melt from the forming tool. Upstream of the forming tool or in the region of the forming tool, a cooling device is arranged in the passage, wherein the cooling device includes a cooling element and a mixing element, which is arranged in the interior of the passage, so that the cooling element and the mixing element can be passed by the plastic melt in the operating state, so that a mixture and a homogenization of the plastic melt can be obtained by the cooling element and the mixing element. According to an embodiment, the forming tool may include a cooling device. The tube can be further cooled downstream of the second end along a channel-shaped cooling section. For a thick-walled tube, a long cooling time is required, Therefore, the cooling section can have a length of up to 100 m, for thicker-walled tubes also up to 200 m.

The cooling element and the mixing element are arranged such that they project into the core flow of the plastic melt, so that they can be passed by the plastic melt, In addition, the cooling element or the mixing element may also be configured such that the wall flow through the cooling element or the mixing element can be cooled. In particular, the cooling element or the mixing element may contain a guide element in order to mix the wall flow with the core flow.

According to an embodiment, the passage has a first passage portion containing the conveyor. According to an embodiment, the passage has a second passage portion, which adjoins the first passage portion. The passage has a third passage portion which connects to the second passage portion. According to an embodiment, the third passage portion includes the forming tool. In particular, the cooling device can be arranged in the second passage portion. According to an embodiment, a plurality of cooling devices may be provided. The cooling devices may be arranged in a parallel arrangement or in a serial arrangement.

According to an embodiment, the cooling device may include a static mixer or be designed as a static mixer. In particular, the cooling element may be at least partially formed as a mixing element. A plurality of cooling elements may be provided. The cooling element may be formed as a web element. The cooling element or at least a part of the cooling elements may include a passage through which a cooling fluid flows in operation.

In an embodiment, the tube may include a plurality of layers. The layers may contain various plastic materials, at least a portion of the layers may also contain a material which is not attributable to the group of plastic materials. In particular, each of the layers can be produced in a separate extruder. A passage can be provided for each of the layers, by means of which the layer is transported to the forming tool. In particular, the passages for the layers can be guided into the forming tool. According to an embodiment, a plurality of annular passages may be provided in the forming tool. The annular passages can be merged upstream of the second end into a single annular passage. The forming tool may include a die member, in particular an annular die. According to an embodiment, the extruder may be configured as a single-screw extruder.

The method and the associated device are preferably used for the manufacture of a thick-walled tube according to any one of the exemplary embodiments described above.

### BRIEF DESCRIPTION OF THE DRAWINGS

The method and device according to the invention will now be illustrated with reference to some embodiments. It is shown in

FIG. 1 a device for performing the method according to a first embodiment,

FIG. 2 a device for performing the method according to a second embodiment.

### DETAILED DESCRIPTION

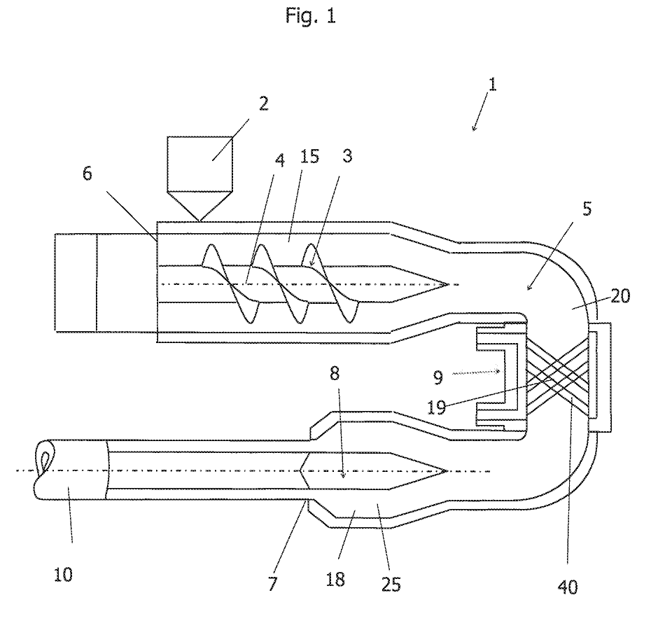

FIG. 1 shows a device 1 for manufacturing a tube 10 made of plastic material, comprising a plastic material container 2 for receiving the plastic material, an extruder 3, wherein the extruder 3 includes a conveyor 4, for example an extruder screw or a piston, which is arranged in a passage 5. The passage 5 has a first end 6, wherein the plastic material is contained in the passage 5 downstream of the first end 6. The plastic material container 2 is connectable via a supply line to the passage 5 or connected thereto. There may be provided a plurality of plastic material containers 2 for various plastics materials. Also, containers for additives, propellants or the like may optionally be provided. The passage 5 contains a heat supply device, so that the plastic material in the passage 5 is convertible to a plastic melt. The heat supply device may include a heater, which is not shown in the drawing. The extruder screw may be formed as a heat supply device or contain a heat supply device.

The passage 5 has a second end 7, wherein the passage 5 forms a connection for the plastic melt from the extruder 3 to a forming tool 8. The forming tool 8 includes an annular passage 18 for producing the tube 10 from the plastic melt. The annular passage 18 extends to the second end 7, wherein the second end 7 includes an opening for the discharge of the plastic melt from the forming tool 8. A cooling device 9 is arranged in the passage 5 upstream of the forming tool 8, wherein the cooling device 9 includes a cooling element 19 and a mixing element 40 which is arranged in the interior of the passage 5, so that the plastic melt flows around the cooling element 19 and the mixing element 40 in the operating state such that a mixing of the plastic melt can take place by the mixing element 40 and a cooling of the plastic melt by the cooling element 19. According to an embodiment, the tube 10 has an outer diameter of at least 100 mm. The tube 10 may have a wall thickness of at least 3 mm. According to an embodiment, the tube 10 has an outer diameter of at least 200 mm. The tube 10 may have a wall thickness of at least 20 mm. The plastic melt can flow around the cooling element 19 and the mixing element 40, if it is arranged such that it projects at least partially into the core flow of the plastic melt. In addition, the cooling element 19 and the mixing element 40 may also be configured such that the wall flow can be cooled by the cooling element 19. In particular, the mixing element 40 may include a guide element to mix the wall flow with the core flow.

According to an embodiment, the passage 5 has a first passage portion 15, which contains the conveyor 4. The passage 5 has a second passage portion 20, which adjoins the first passage portion 15. The passage 5 has a third passage portion 25, which adjoins the second passage portion 20, the third passage portion 25 containing the forming tool 8. In particular, the cooling device 9 may be arranged in the second passage portion 20. According to an embodiment, a plurality of cooling devices 9 may be provided. The cooling devices 9 can be arranged in a parallel arrangement or in a serial arrangement, which is not shown in the drawing in FIG. 1.

The cooling device 9 may contain a static mixer or be designed as a static mixer. In particular, the cooling element 19 may be at least partially formed as the mixing element 40.

The cooling element 19 and the mixing element 40 may form a unit. A plurality of cooling elements 19 or mixing elements 40 may be provided. The cooling element 19 or the mixing element 40 may be formed as a web element. The cooling element 19 or at least a part of the cooling elements may include a passage through which a cooling fluid flows.

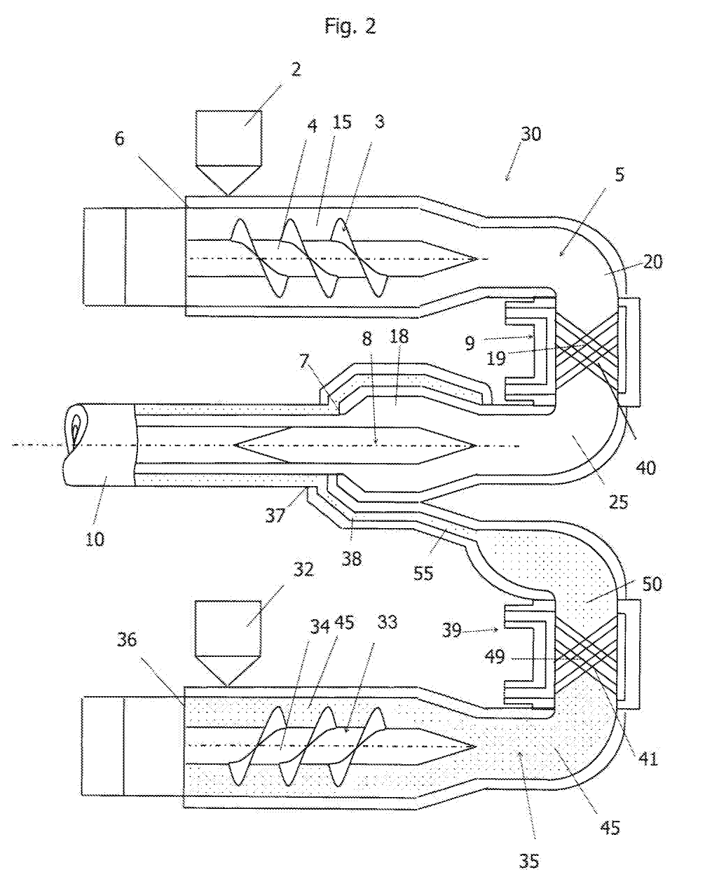

According to the embodiment of a device 30 shown in FIG. 2, the tube 10 may include a plurality of layers. FIG. 2 shows a device 30 for producing a tube 10 made of plastic material, comprising a plastic material container 2, 32 for receiving the plastic material, a first and a second extruder 3, 33. The first and second extruder 3, 33 each contain a conveyor 4, 34, for example, an extruder screw or a piston, which is arranged in each case in a first or second passage 5, 35. The first passage 5 has a first end 6, the second passage 35 has a first end 36, wherein the plastic material is included downstream of the corresponding first end 6, 36 in the passage 5, 35. Each of the first or second passages 5, 35 may include a heat supply device, so that the plastic material in the corresponding passage 5, 35 is convertible to a plastic melt. The heat supply device may include a heater, which is not shown in the drawing. Each of the passages 5, 35 have a second end 7, 37 each, wherein the first passage 5 and the second passage 35 each form a connection for the plastic melt from the first and second extruder 3, 33 to form a forming tool 8. The forming tool 8 includes a first annular passage 18 and a second annular passage 38 for the manufacture of the tube 30 from the plastic melt.

The first annular passage 18 extends to the second end 7, wherein the second end 7 includes an opening for the discharge of the plastic melt from the forming tool 8. The second annular passage 38 extends to the second end 37, wherein the second end 37 includes an opening for the discharge of the plastic melt from the forming tool 8. Upstream of the forming tool 8, a first cooling device 9 is arranged in the first passage 5 and a second cooling device 39 in the second passage 35, wherein the first cooling device 9 includes a first cooling element 19 and a first mixing element 40, which is arranged in the interior of the first passage 5 in that the plastic melt flows around the first cooling element 19 and the first mixing element 40 in the operating state, so that the plastic melt is mixed by the first mixing element 40. A second cooling device 39 is arranged in the second passage 35, wherein the second cooling device 39 includes a second cooling element 49 and a second mixing element 41, which is arranged in the interior of the second passage 35, so that the plastic melt flows around the second mixing element 41 and the second cooling element 49 in the operating state, so that the plastic melt is mixed by the second mixing element 41. According to an embodiment, the tube 30 has an outer diameter of at least 100 mm. The tube 30 may have a wall thickness of at least 3 mm. According to an embodiment, the tube 30 has an outer diameter of at least 200 mm. The tube 30 may have a wall thickness of at least 20 mm. The plastic melt can flow around by each of the first or second cooling elements 19, 49, if it is arranged such that it projects into the core flow of the plastic melt. In addition, each of the first or second cooling elements 19, 49 may also be configured such that the wall flow can be cooled by the corresponding cooling element 19, 49. In particular, the mixing elements 40, 41 may include a guide element to mix the wall flow with the core flow.

According to an embodiment, the second passage 35 has a first passage portion 45, which contains the conveyor 34. The second passage 35 has a second passage portion 50, which adjoins the first passage portion 45. The second passage 35 has a third passage portion 55, which adjoins the second passage portion 50, the third passage portion 55 containing the forming tool 8. In particular, the cooling device 39 may be arranged in the second passage portion 50. According to an embodiment, a plurality of cooling devices 39 may be provided. The cooling devices 39 can be arranged in a parallel arrangement or in a serial arrangement, which is not shown in the drawing in FIG. 2.

The first cooling device 9 or the second cooling device 39 may contain a static mixer or be designed as a static mixer. In particular, the second cooling element 49 may be formed at least partially as a mixing element 41. A plurality of cooling elements 49 may be provided. The cooling element 49 or the mixing element 41 may be formed as a web element. The one or more cooling elements 49 or at least a portion of the cooling elements may include a passage through which a cooling fluid flows in operation.

The layers constituting the tube 30 may contain various plastics materials, at least a part of the layers may also contain a material which is not attributable to the group of plastics. In particular, each of the layers can be produced in a separate extruder 3, 33. For each of the layers a passage 5, 35 can be provided, by means of which the corresponding layer is transported to the forming tool 8. In particular, the layers can be guided by means of the passages 5, 35 into the forming tool 8. According to an embodiment, a plurality of annular passages 18, 38 may be provided in the forming tool 8. The annular passages 18, 38 may be merged upstream of the second end 7, 37 into a single annular passage. The forming tool 8 may include a die element, in particular an annular die. According to an embodiment, the extruder 3, 33 may be formed as a single-screw extruder.

The web elements of the first or second cooling element 19, 49 or the first or second mixing element 40, 41 may be assigned according to each of the embodiments to a first and a second web element group. The cooling device 9, 39 may comprise a first group of web elements as well as a second group of web elements. Each group may comprise a plurality of web elements. Depending on the width of the web elements and the flow passage width 1 to 100, preferably 1 to 50 web elements may belong to one group. The web elements belonging to a group can be arranged parallel to each other. The side surfaces of the web elements can be aligned in the direction of the impinging plastic melt flow and span a common plane according to an embodiment.

The web elements of the first group preferably intersect with the web elements of the second group. A web element of the first group according to this embodiment connects to a web element of the second group. The web element of the first group is thus arranged crosswise to the web element of the second group. The web elements of the first group thus alternate with the web elements of the second group. The first and second groups can each span a plane that is inclined at an inclination angle of 25 to 75 degrees to the main direction of flow. In particular, the angle may comprise 30 up to and including 60 degrees, in many cases the angle may be substantially 45 degrees.

Web elements can contain one or more channels through which a heat transfer fluid flows. The cooling device may include a pedestal or shell element that may or may not include a distribution channel for distribution of a heat transfer fluid or a collection channel for merging the heat transfer fluid from a plurality of discharge channels. For example, each of a supply channel and a discharge channel are in fluid communication with the first and second end of the rod member. For each of the web elements containing channels, at least one supply channel is provided, which supplies the heat transfer fluid to the corresponding channel in the web element and a discharge channel which directs the heat transfer fluid from the channel in the web element in a collecting channel. In this case, the heat transfer fluid is supplied and/or discharged through the tube element surrounding the plastic melt and/or the jacket of the tube element surrounding the plastic melt.

The channels extending in the web elements may have an oval or circular cross-section. The channels may also have other cross-sectional areas, for example channels with a triangular, quadrangular or polygonal, cross-sectional area.

It will be apparent to those skilled in the art that many other modifications are possible in addition to the described embodiments without departing from the inventive concept. For example, a static mixer according to EP 2851118 B1 can be used. The object of the invention is thus not limited by the foregoing description and is determined by the scope of protection defined by the claims. The widest possible reading of the claims is decisive for the interpretation of the claims or the description. In particular, the terms “contain, comprise” or “include” are to be interpreted as referring to elements, components or steps in a non-exclusive sense, to indicate that the elements, components or steps may be present or used can be combined with other elements, components or steps that are not explicitly mentioned. If the claims refer to an element or component from a group which may consist of A, B, C, N elements or components, that formulation should be interpreted as requiring only a single element of that group, not a combination of A and N, B and N or any other combination of two or more elements or components of this group.

1. A method for the manufacture of a tube containing a plastic material, wherein the plastic material is melted in an extruder so that a plastic melt is obtained, wherein the extruder includes a passage, a conveyor is arranged in the passage, wherein the passage has a first end, wherein the plastic material is introduced downstream of the first end into the passage, wherein the plastic material is conveyed through the passage and is converted into a plastic melt, wherein the passage has a second end, wherein the plastic melt is directed through the passage into a forming tool, wherein the tube is produced by means of the forming tool, wherein the tube leaves the passage at the second end, wherein the passage in the forming tool includes a mandrel, so that the plastic melt flows from the passage into an annular passage arranged in the forming tool, wherein the annular passage is arranged around the mandrel, wherein the plastic melt is guided through a cooling device, wherein the cooling device a cooling element and a mixing element, which is arranged in the interior of the passage, wherein the plastic melt flows around the cooling element and the mixing element, so that the plastic melt is cooled through the cooling element and the plastic melt is mixed by the mixing element, wherein the cooling element is arranged at least partially within the mixing element.

2. The method according to claim 1, wherein the mixing element or the cooling element comprises a plurality of web elements.

3. The method according to claim 2, wherein the web elements are arranged crosswise to each other.

4. The method according to claim 2, wherein at least a part of the web elements includes a cooling passage.

5. The method according to claim 1, wherein the tube has a wall thickness of at least 3 mm.

6. The method according to claim 1, wherein the tube has an outer diameter of at least 100 mm.

7. The method according to claim 1, wherein the maximum temperature of the plastic melt differs from the minimum temperature of the plastic melt by not more than 10 degrees, so that the plastic melt downstream of the cooling device is homogenized over the flow cross section.

8. The method according to claim 1, wherein the tube comprises at least two layers.

9. The method according to claim 8, wherein each of the layers which comprises at least 10% by weight of the plastic melt is cooled by means of a cooling device.

10. The method according to claim 8, wherein each of the layers is produced by a respective extruder, wherein each of the layers is guided through a separate passage.

11. The method according to claim 1, wherein the conveyor comprises an extruder screw, which is arranged in the passage.

12. The method according to claim 1, wherein the passage includes a first passage portion containing the conveyor, wherein the passage contains a second passage portion which adjoins the first passage portion, wherein the passage contains a third passage portion adjoining the second passage portion, wherein the third passage portion contains the forming tool.

13. The method of claim 12, wherein the cooling device is arranged in the second passage portion, such that the plastic melt in the second passage portion passes through the cooling device.

14. The method according to claim 1, wherein the plastic material contains at least one element from the group consisting of polyethylene or polypropylene.

15. The method according to claim 14, wherein the percentage of polyethylene or polypropylene is at least 50% by weight.

16. The method according to claim 1, wherein the cooling device is arranged upstream of the forming tool.

17. A method for the manufacture of a tube containing a plastic material, said method comprising the steps of
melting a mass of plastic material within a passage of an extruder to obtain a plastic melt;
guiding the plastic melt through a cooling element within said passage to cool the plastic melt and a mixing element within said passage to mix the cooling plastic melt and wherein the cooling element is arranged at least partially within the mixing element; and
thereafter directing the plastic melt through said passage and annularly between a mandrel within said passage and said passage to form a tube for passage from an exit end of said passage.

18. A method as set forth in claim 17 wherein said mandrel is concentrically spaced within said passage to form a tube with a thickness of at least 3 mm.

19. A method as set forth in claim 17 wherein said passage is of a diameter to form a tube with an outer diameter of at least 100 mm.

20. A method as set forth in claim 17 wherein said step of melting and said cooling element maintain a temperature differential of not more than 10 degrees C. between the maximum temperature of said melt and the minimum temperature of said melt,

21. A method for the manufacture of a tube containing a plastic material, said method comprising the steps of
melting a first mass of plastic material within a passage of a first extruder to obtain a first plastic melt;
guiding the first plastic melt through a cooling element within said passage to cool the plastic melt and a mixing element within said passage to mix the cooling plastic melt and wherein the cooling element is arranged at least partially within the mixing element;
thereafter directing the first plastic melt through said passage and annularly between a mandrel within said passage and said passage to form a first tube for passage from an exit end of said passage;
melting a second mass of plastic material within a passage of a second extruder to obtain a second plastic melt;
guiding the second plastic melt through a cooling element within said passage of said second extruder to cool the second plastic melt and a mixing element within said passage to mix the second cooling plastic melt and wherein the cooling element is arranged at least partially within the mixing element;
thereafter directing the second plastic melt from an exit end of said second extruder spaced annularly about said exit end of said passage of said first extruder and onto said first tube to form a multilayer tube.
